(19) United States
(12) Patent Application Publication
(10) Pub. No.: US 2005/0183548 A1
(43) Pub. Date: Aug. 25, 2005

(54) Apparatus for removing damaged fasteners

(76) Inventor: Bill R. Horobec, St. Petersburg, FL (US)

Correspondence Address: LARSON AND LARSON, 11199 69TH STREET NORTH, LARGO, FL, 33773, US

(21) Appl. No.: 11/118,989

(22) Filed: Apr. 29, 2005

Related U.S. Application Data
(63) Continuation-in-part of application No. 10/756,788, filed on Jan. 14, 2004.

(51) Int. Cl. B25B 13/50

(52) U.S. Cl. 81/53.2

(57) ABSTRACT

A socket head having a cylindrical external configuration with an upper end and a lower end and with a cavity on the upper end adapted to receive the end of a turning tool. The lower end of the socket head is fabricated with a frustum shaped cavity. The frustum shaped cavity has an interior surface formed with a plurality of inverted L-shaped projections that are at angles from its main axis. Each inverted L-shaped projection is in a helix pattern twisting down into the tool. The radius of the angles is smaller toward the interior of the tool, creating a contact surface for a variety of fastener sizes.

### PRIOR APPLICATIONS

This application is a continuation-in-part from application Ser. No. 10/756,788, filed Jan. 14, 2004 (now abandoned).

### BACKGROUND OF THE INVENTION

1. Field of the Invention

The present invention relates to a tool for the removal of damaged and undamaged fasteners such as nuts, bolts and studs. More particularly, it pertains to removing damaged fasteners, i.e., the heads have been damaged or rounded off through the use of sockets or wrenches.

2. Description of the Prior Art

The use of socket heads for removing damaged fasteners and techniques for facilitating such removal when the heads are rounded off is known in the prior art. More specifically, socket heads for removing damaged fasteners and techniques for facilitating such removal when the heads are rounded off are known to consist of the familiar, expected and obvious structural configurations.

By way of example, the prior art discloses in U.S. Pat. No. 5,123,310 to McManus a socket for turning fastener heads having deformed head surfaces.

U.S. Pat. No. 4,607,547 to Martus discloses a stripped hex head drive socket.

U.S. Pat. No. 4,084,454 to Day discloses a socket head tool.

U.S. Pat. No. 4,063,472 to MacIntyre discloses a removable actuatable device for rotary knobs.

U.S. Pat. No. 3,847,042 to Wilson discloses a hand star wrench.

U.S. Pat. No. 5,551,320 to Horobec discloses a socket with V-shaped teeth spiraled in a tapered cylinder, and is hereby included by reference. Both sides of the V have essentially equal lengths and angles.

Lastly, U.S. Pat. No. 3,996,819 to King discloses a socket wrench attachment without integral teeth.

In this respect, the tool for the removal of damaged fasteners such as nuts, bolts and studs according to the present invention substantially departs from the constructs of the prior art.

Therefore, it can be appreciated that there exists a continuing need for a new and improved tool for the removal of damaged fasteners such as nuts, fasteners and studs, i.e., wherein the heads have been rounded off through the use of sockets having teeth capable of biting into such heads. In this regard, the present invention substantially fulfills this need.

### SUMMARY OF THE INVENTION

In view of the foregoing disadvantages inherent in the known types of socket heads for removing damaged fasteners and techniques for facilitating such removal when the heads are rounded off, the present invention provides an improved tool for the removing of damaged fasteners, such as nuts, bolts and studs and nuts or fasteners from long threaded studs. As such, the general purpose of the present invention, which will be described subsequently in greater detail, is to provide a new and improved tool for the removing of damaged fasteners, such as nuts, bolts, and studs which has all the advantages of the prior art and none of the disadvantages.

The present invention is a tool for removing fasteners, studs and nuts with damaged heads. Frequently, when installing or trying to remove a fastener, stud or nut, a mechanic may chew up or round off its head, making it difficult to grab hold of the head with a conventional wrench or other tools. Studs become rusty and threads worn. Other tools might have the capability of removing the damaged fastener, but once the fastener is removed it can't be removed from the tool easily if at all. The present invention pulls the damaged fastener in a direction towards the inside of the tool with an increased force and the design of the angles on each leg allows for easy removal of the damaged fastener from the tool. Also, it may be difficult to get to the damaged fastener due to a precarious location or limited amount of space. By design, the present invention works equally as well for the removal of undamaged fasteners.

The present invention includes a socket head with a substantially cylindrical external configuration with cavities at an upper end and a lower end. In some embodiments, the upper end has several flat surfaces extending beyond the cylindrical body allowing the tool to receive a variety of wrench configurations for providing leverage in the removal of the fastener. In some embodiments, the cavity at the upper end has a square recess adapted to receive the end of a driver or ratchet wrench for providing leverage in the removal of the fastener. The lower end cavity of the socket head has a major recess of a generally frustum configuration with a depth constituting perhaps 50 percent or less of the overall body length. The lower end cavity has an interior surface formed with a plurality of inverted L-shaped projections that are at a greater angle from their main axis of between 85 and 105 degrees, preferably 96 degrees. The inverted L-shaped projections are on a helix from 11 to 18 degrees, preferably 12 degrees. Both the angle and the helix are in a taper forming the frustum. The taper allows the tool to be placed over damaged fasteners that no longer have a standard size; thereby a slightly smaller fastener will fit further into the socket head. The angle of the taper must balance between allowing the socket head to work on a range of fastener sizes while also providing maximum engagement surface area. An angle of taper from between 5 degrees and 15 degrees is sufficient, preferably 5.5 degrees. The leg of the inverted L-shaped projections has a radius at the base. These projections are integral with the socket and extend radially inwardly from the lower end with valleys intermediate to the inverted L-shaped projections, thereby forming a plurality of angles with radially interior teeth. Each of the angles has an apex with two faces. The face of each angle is offset from the radius of the cylinder. The apex of each tooth is angularly oriented with respect to the axis of the cylinder. The axial interior of the major recess has a smaller diameter than the axial exterior of the major recess. The bottom cavity continues through the socket head beyond the projections into and joins with the square drive cavity (upper end cavity) at the upper end. When placed over the head of a damaged fastener, the socket head is rotated with a ratchet motion. The teeth will pull downwardly over and into the damaged fastener, biting into its exterior surface to affect a coupling there between for rotation of the socket head and associated fastener to effect its removal. The damaged fastener can be easily removed from this tool, perhaps by ratcheting in the opposite direction. In various embodiments, any number of inverted-L shaped projections may be provided, but six is preferred to provide a generally hexagonal configuration that will facilitate the removal of undamaged fasteners as well as damaged fasteners.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claim appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved tool for the removing of damaged fasteners, such as nuts, bolts and studs which has all the advantages of the prior art socket heads for removing fasteners and techniques for facilitating such removal when the heads are damaged or rounded off.

It is another object of the present invention to provide a new and improved tool with much greater gripping ability for the removal of damaged fasteners such as nuts, bolts and studs.

It is a further object of the present invention to provide new and improved tool for the removing of damaged fasteners such as nuts, bolts and studs which is of a durable and reliable construction. In addition, the damaged fastener can be easily removed from the tool.

An even further object of the present invention is to provide a new and improved tool for the implementation and removal of an undamaged fastener as well as the removal of damaged fasteners such as nuts, bolts and studs.

Still another object of the present invention is to remove damaged fasteners wherein the heads have been deteriorated from rust or rounded off as through the use of an improper sized socket having teeth.

Lastly, it is an object of the present invention to provide a new and improved device for the removal of damaged fasteners with rusted or rounded off heads. The socket head has a substantially cylindrical external configuration with an upper end and a lower end and with a square recessed surface in the upper end and is adaptive to receive the end of a turning tool. The lower end of the socket head is fabricated with a major recess of a generally frustum configuration. The major recess has an interior surface formed with a plurality of inverted L-shaped projections that are at angles from its main axis. Each inverted L-shaped projection is configured as a helix. Both the angle and the helix are in a taper, forming a frustum. These projections are integral with the socket and extend radially inwardly from the lower end thereby forming a plurality of angles with radially interior teeth. Each of the angles has an apex with two faces. The faces of each angle are offset from the radius of the cylinder. The apex of each tooth is angularly oriented with respect to the axis of the cylinder. The axial interior of the major recess has a smaller diameter than the axial exterior of the major recess whereby when placed over the damaged fastener and when the socket head is rotated with a ratchet motion, the teeth will pull downwardly over the damaged fastener and bite into its exterior surface to effect a coupling there between for rotation of the socket head and associated damaged fastener to effect its removal. The damaged fastener can easily be removed by tapping it out from the top side.

### BRIEF DECRIPTION OF THE DRAWINGS

The invention will be better understood by those having ordinary skill in the art by reference to the following detailed description when considered in conjunction with the accompanying drawings in which:

FIG. 1 is a top isometric view showing the socket head design of the present invention.

FIG. 2 is a bottom isometric view showing a standard interior socket wrench attachment method (square), and a standard exterior wrench attachment method (hexagon) of the present invention.

FIG. 3 is a top view showing how the socket head design tapers inward and rotates counter-clockwise (helix) of the present invention.

FIG. 4 is a top isometric view showing the socket head with a socket wrench and bolt of the present invention.

FIG. 5 is a sectional view of the present invention.

FIG. 6 is a sectional view showing a bolt with a rounded hex-head loosely placed into the socket head of the present invention.

FIG. 7 is a sectional view showing a bolt with a rounded hex-head being rotated downwardly to be repositioned into the tapered helix of the present invention.

FIG. 8 is a view of a damaged with a bolt protruding through the socket head of the present invention.

FIG. 9 is a view of the socket head placed over a rounded hex-nut with its attached bolt protruding through the socket head of the present invention.

### DETAILED DESCRIPTION OF THE DRAWINGS

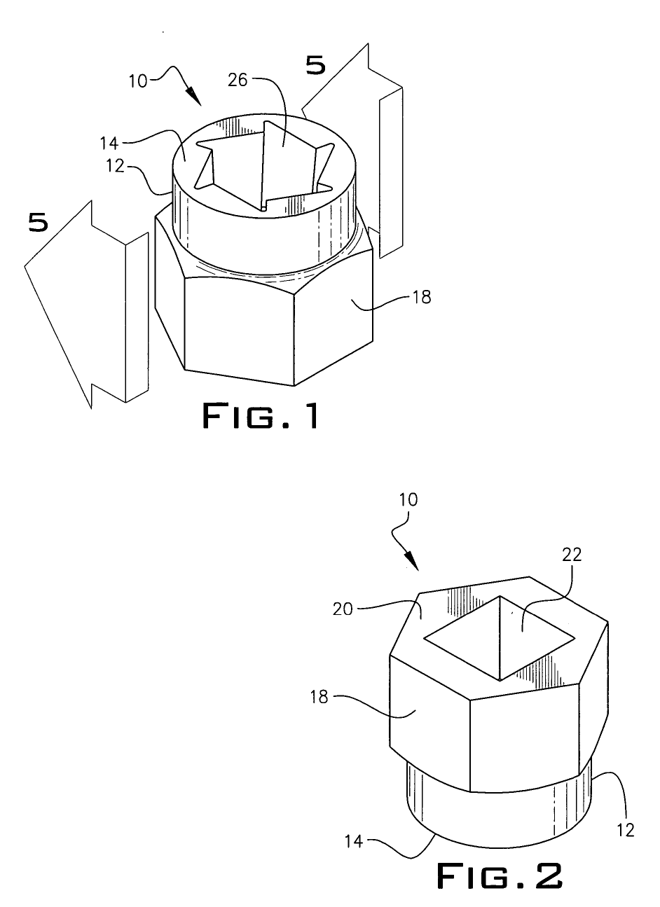

With reference now to the drawings, and in particular to FIG. 1 through FIG. 9 thereof, a new and improved tool for the removing of damaged fasteners such as nuts, bolts and studs embodying the principles and concepts of the present invention and generally designated by the reference numeral 10 will be described.

The present invention, a tool for the removal of damaged fasteners such as nuts, bolts and studs, may comprise of a plurality of socket head sizes. The various socket head sizes are configured and correlated with respect to various fastener sizes so as to attain the desired objective.

More specifically, the present invention is a tool or socket head 10 of a size configured to match a range of fastener sizes, perhaps providing a plurality of socket heads 10 corresponding to a plurality of fastener sizes. Each socket head is formed of a substantially cylindrical exterior configuration 12. In some embodiments, flat sides 18 extend horizontally beyond the cylindrical lower end and allow for application of a wrench to provide leverage in the removal process. There may be a plurality of flat surfaces sized and configured to match standard wrench sizes, perhaps 3, 4, 6 or 8 sides. Referring to FIG. 2, in some embodiments, the top 20 has a square opening 22 forming a cavity that continues partly into the socket head's interior. This square opening 22 and cavity are adapted to receive the end of a ratchet wrench or square driving tool devised for providing leverage in the removal of a fastener, as known in the art. In some embodiments, only the square opening adapted to receive a driver tool or ratchet wrench is provided. In some embodiments, there is no square opening 22, and the plurality of flat surfaces is provided configured to match with standard wrench sizes. Yet, still in other embodiments, both the square opening and the flat surfaces are provided for added flexibility in the use of a driver, wrench or both.

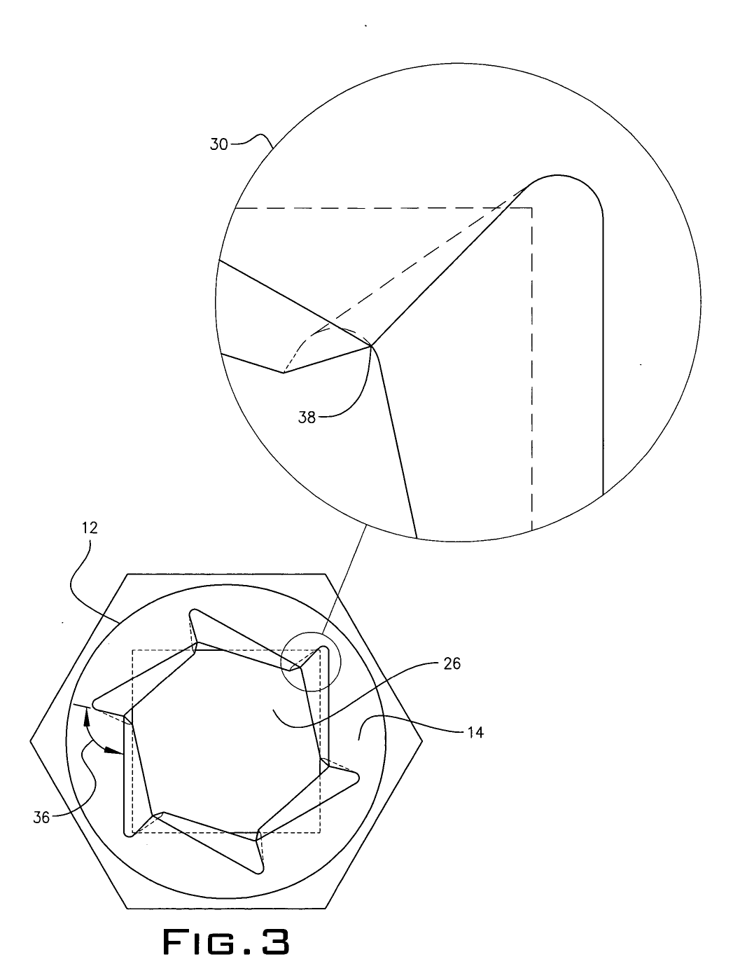

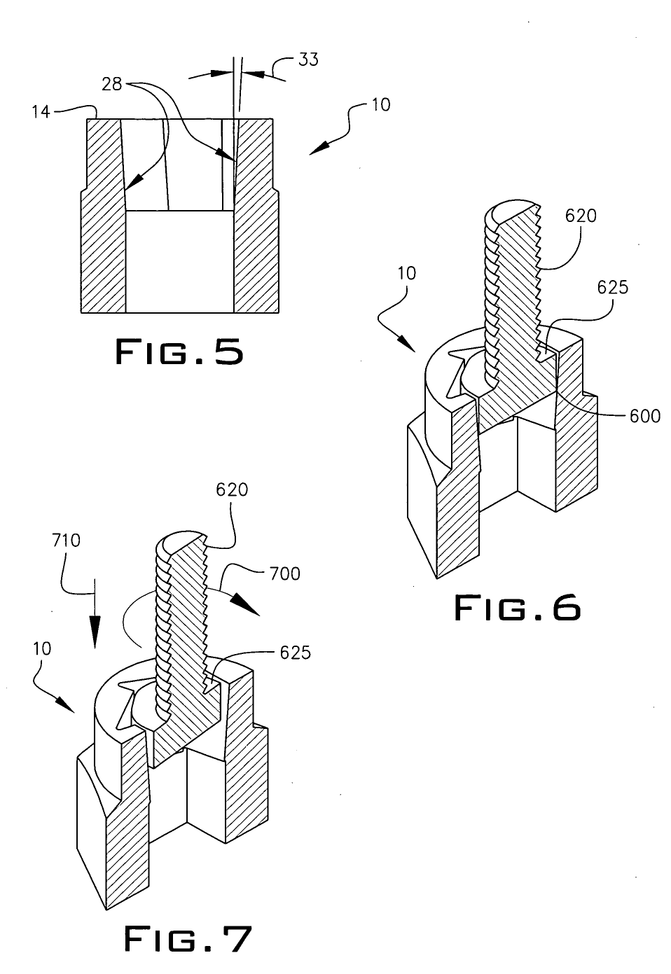

Referring now to FIG. 3, the lower end 14 of each socket head is fabricated with an opening 26. Referring also to FIG. 5, the opening 26 leads to a cavity of generally frustum shape 28. The frustum cavity 28 includes a plurality of inverted L-shaped projections 30 emanating from the sidewalls of the frustum cavity 28; each inverted L-shaped projection has two sides meeting at an angle of from 85 to 105 degrees, preferably 96 degrees. The inverted L-shaped projections 30 twist in a helix at an 11 to 18 degree twist between the bottom edge and the innermost point of the frustum cavity 28, preferably 12 degrees. The walls of the frustum cavity 28 are on a taper 33 inwardly from 5 to 15 degrees, preferably 5.5 degrees. The inverted L-shaped projections form a plurality of surfaces meeting at angle 36 all of which create radially interior teeth. The angle 36 of each tooth is angularity oriented with respect to the axis of the cylinder.

The axial interior of the frustum cavity 28 has a smaller diameter than its diameter at the bottom of the tool. In this manner, when placed over a damaged fastener, stud or nut, and rotated with a ratchet motion, the teeth pull the socket downwardly over the head of the fastener and bite into its exterior surface. This will affect a coupling between the socket head and the fastener. Counter clockwise rotation of the cylindrical member of the socket head and coupled fastener will function to effect the removal of the fastener, although in another embodiment, a similar tool may be produced for reverse-threaded fasteners.

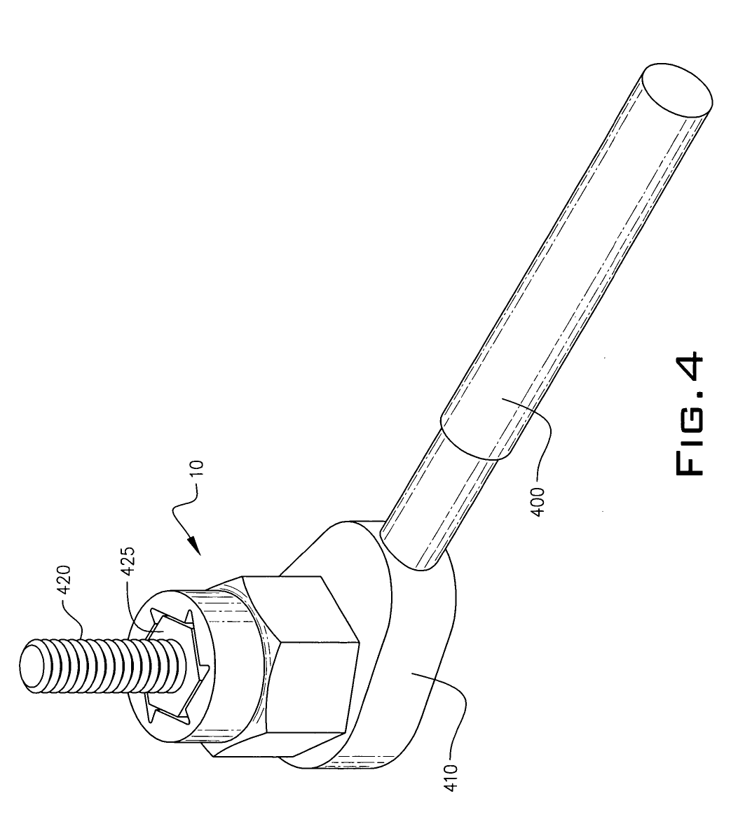

Continuing with FIG. 4, the socket head 10 is shown snapped into a socket wrench 400 which has a ratchet head 410. Nestled within the socket head 10 is a bolt 420 with a bolt head 425 shown for reference purposes. In this case, the bolt head 425 has flat surfaces, but the socket head 10 is useful in removing bolts 420 wherein the bolt head 425 is worn, possibly worn by the use of a different tool in a failed attempt at removal.

Referring now to FIG. 6 and FIG. 7, a cut-away view of the socket head 10 is shown with a bolt 620 that has a worn bolt head 625 that would be otherwise difficult to unfasten. In this example, the bolt head 625 makes contact with the inverted L-shaped teeth 38 within the frustum cavity 28 at point 600. As the tool 10 is rotated 700 to remove the bolt 620, the inverted L-shaped teeth pull the bolt head 625 into the socket 10 in a direction 710 by way of the helix configuration.

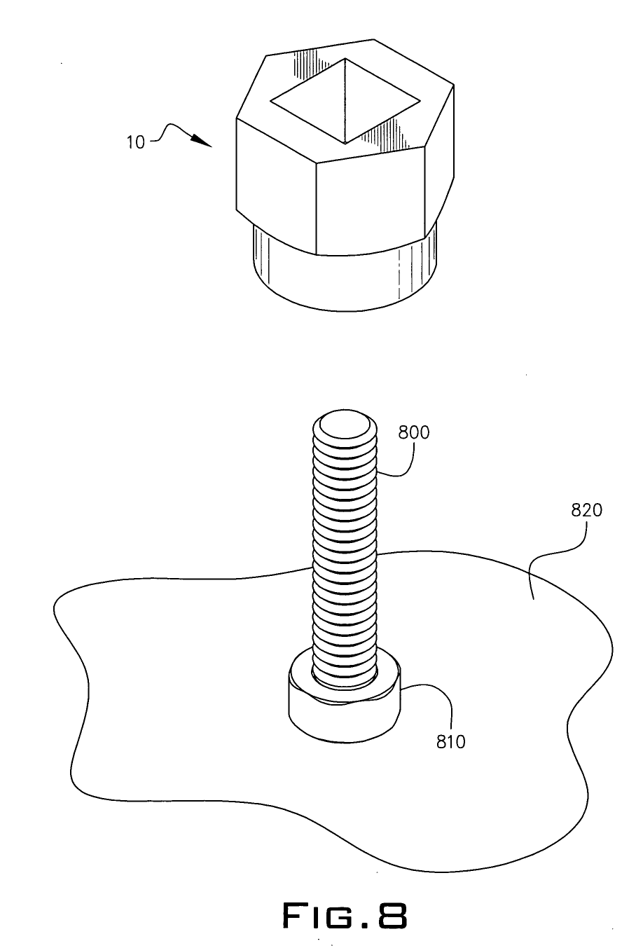

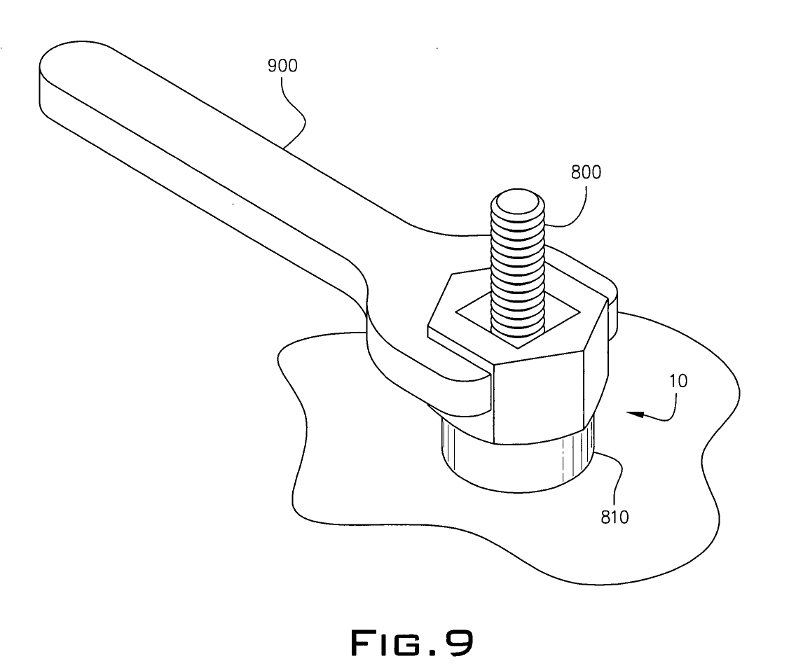

Referring now to FIG. 8 and FIG. 9, the socket head 10 is shown ready to remove a fastener 810 from a bolt 800 that passes through a surface 820. To effect removal, the socket head 10 passes over and down the bolt 800 and into contact with the fastener 810. A wrench or other suitable tool 900 then engages with the flat surfaces of the socket 10 and is rotated on a counter clockwise direction to effect removal of fastener 810.

The present invention includes a set of socket head that fit onto standard ratchets or drivers or wrenches. They may be made of hardened tool steel and be provided in a range of sizes in anticipation of a range of sizes of fasteners that may have rounded surfaces. The socket head of the tool may be fabricated such that it has sharp teeth that surround its inner surface.

Referring again to FIG. 8 and FIG. 9, to remove a worn fastener such as a worn nut 810 from a bolt 810, a proper size fastener remover or socket head of the present invention 10 is placed over the damaged fastener 810. A wrench 900 engages with the flat surfaces 18 of the socket head 10 and is rotated in a counter-clockwise direction (normal threaded nuts) thus drawing the sharp teeth tighter into the fastener 810. The socket head 10 pulls itself down on the damaged fastener 810, enabling the tool to grab the fastener 810 securely and remove the damaged fastener 810.

With respect to the above description then, it is to be realized that the optimum dimensional relationships for the parts of the invention to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Equivalent elements can be substituted for the ones set forth above such that they perform in substantially the same manner in the same way for achieving the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A tool for the removal of fasteners, the tool comprising:
a socket head having a top end, a bottom end and having a substantially cylindrical shape;
a substantially square cavity at the top end for acceptance of a driver; and
a frustum shaped cavity at the bottom end for engagement with a fastener, the frustum shaped cavity having multiple inverted L-shaped projections from a sidewall, each inverted L-shaped projection having two edges meeting at an angle, and the inverted L-shaped projections forming a helix starting at a bottom edge of the socket head and the helix rotating into the frustum shaped cavity at a helix rotation angle.

2. The tool of claim 1, wherein the angle is from 85 to 105 degrees.

3. The tool of claim 1, wherein the helix rotation angle is between 11 and 18 degrees.

4. The tool of claim 1, wherein the frustum tapers inwardly at an angle of from 5 to 15 degrees.

5. The tool of claim 2, wherein the meeting angle is 96 degrees.

6. The tool of claim 3, wherein the helix rotation angle is 12 degrees.

7. The tool of claim 4, wherein the frustum tapers at an angle of 5.5 degrees.

8. The tool of claim 1, wherein the fastener has an outer surface that has been substantially worn.

9. The tool of claim 1, wherein said substantially cylindrical shape has a plurality of flat surfaces near the top end of the socket head adapted to engage with a wrench.

10. A tool for the removal of fasteners, the tool comprising:
a socket head having a top end, a bottom end and having a substantially cylindrical outer side;
a substantially square cavity at the top end for acceptance of a driver;
a plurality of flat surfaces on an outer side surface near the top end of the socket head adapted to engage with a wrench; and
a frustum shaped cavity depending from the bottom end for engagement with a fastener, the frustum shaped cavity having multiple inverted L-shaped projections from a sidewall, each inverted L-shaped projection having edges meeting at an angle, the inverted L-shaped projections forming a helix starting at a bottom edge of the socket head and the helix rotating into the frustum shaped cavity at a helix rotation angle.

11. The tool of claim 10, wherein the angle is from 85 to 105 degrees.

12. The tool of claim 10, wherein the helix rotation angle is between 11 and 18 degrees.

13. The tool of claim 10, wherein the frustum tapers inward at an angle of from 5 to 15 degrees.

14. The tool of claim 11, wherein the angle is 96 degrees.

15. The tool of claim 12, wherein the helix rotation angle is 12 degrees.

16. The tool of claim 13, wherein the frustum tapers at an angle of 5.5 degrees.

17. The tool of claim 10, wherein the fastener has an outer surface that has been substantially worn.

18. A method of removing a worn fastener, comprising:
placing a frustum shaped cavity of a socket head on the worn fastener, said frustum shaped cavity having multiple inverted L-shaped projections, each inverted L-shaped projection having edges meeting at an angle, the inverted L-shaped projections forming a helix starting at a bottom edge of the socket head and the helix rotating into the frustum shaped cavity at a helix rotation angle;
turning said socket head in a loosening direction with respect to said fastener using an extension tool coupled to said socket head, wherein the helix is configured to pull the fastener into the frustum shaped cavity, thereby bonding the inverted L-shaped projections to the worn fastener, thereby allowing the fastener to be turned; and
continuing to turn the socket until the worn fastener becomes unfastened.

19. The method of claim 18 wherein said loosening direction is counter-clockwise.

20. The method of claim 18, wherein the meeting angle is from 85 to 105 degrees.

21. The method of claim 18, wherein the helix rotation angle is between 11 and 18 degrees.

22. The method of claim 18, wherein the frustum tapers at an angle of from 5 to 15 degrees.

23. The method of claim 18, wherein the extension tool is a ratchet wrench.

24. The method of claim 18, whereas the extension tool is a wrench.
